(19) United States
(12) Patent Application Publication
(10) Pub. No.: US 2026/0087404 A1
(43) Pub. Date: Mar. 26, 2026

(54) Training Machine-Learned Models with Temporal Conditioning for Time-Aware Inference

(71) Applicant: DeepMind Technologies Limited, London (GB)

(72) Inventors: Florian Nils Hartmann, Zurich (CH); Matthew Sharifi, Kilchberg (CH)

(21) Appl. No.: 18/897,547

(22) Filed: Sep. 26, 2024

(51) Int. Cl. G06N 20/00

(52) U.S. Cl. CPC G06N 20/00

(57) ABSTRACT

An example method includes processing, using a temporal feature extraction system, a source data item to extract a temporal feature value associated with the source data item. The example method includes constructing a respective training input for a respective training example, the respective training input. The example method includes content obtained from the source data item. The example method includes the extracted temporal feature value. The example method includes generating, using a machine-learned model, a respective training output based on the respective training input, wherein the respective training output includes a content prediction. The example method includes computing, using the respective training output and a respective content evaluation signal for the respective training example, a content prediction loss. The example method includes training the machine-learned model using the content prediction loss.

### BACKGROUND

A computer can receive inputs. The computer can execute instructions to process the inputs to generate outputs using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides a first example method. In some implementations, the first example method includes processing, using a temporal feature extraction system, a source data item to extract a temporal feature value associated with the source data item. In some implementations, the first example method includes constructing a respective training input for a respective training example, the respective training input including: content obtained from the source data item, and the extracted temporal feature value. In some implementations, the first example method includes content obtained from the source data item. In some implementations, the first example method includes the extracted temporal feature value. In some implementations, the first example method includes generating, using a machine-learned model, a respective training output based on the respective training input, wherein the respective training output includes a content prediction. In some implementations, the first example method includes computing, using the respective training output and a respective content evaluation signal for the respective training example, a content prediction loss. In some implementations, the first example method includes training the machine-learned model using the content prediction loss.

In an aspect, the present disclosure provides a second example method. In some implementations, the second example method includes inputting, to a machine-learned model, a respective training input based on a respective training example. In some implementations, the second example method includes generating, using the machine-learned model, a first respective training output based on the respective training input, wherein the first respective training output includes a respective temporal feature prediction. In some implementations, the second example method includes generating, using the machine-learned model, a second respective training output based on the respective training input, wherein the second respective training output includes a content prediction. In some implementations, the second example method includes computing, using the first respective training output and a respective temporal evaluation signal for the respective training example, a temporal feature prediction loss. In some implementations, the second example method includes computing, using the second respective training output and a respective content evaluation signal for the respective training example, a content prediction loss. In some implementations, the second example method includes generating, using the content prediction loss and the temporal feature prediction loss, a parameter update for one or more parameters of the machine-learned model.

In an aspect, the present disclosure provides a third example method. In some implementations, the third example method includes generating a temporally indexed training dataset that includes a plurality of training examples that are respectively associated with a plurality of temporal feature values. In some implementations of the third example method, generating the temporally indexed training dataset includes for each respective training example of the plurality of training examples computing a respective temporal feature value associated with the respective training example. In some implementations of the third example method, generating the temporally indexed training dataset includes for each respective training example of the plurality of training examples storing the respective temporal feature in a data structure that associates the respective temporal feature value with the respective training example. In some implementations, the third example method includes training a machine-learned model using the temporally indexed training dataset, wherein successive parameter updates are computed based on chronologically ordered batches of training examples, wherein the chronologically ordered batches of training examples are populated with training examples based on the plurality of temporal feature values.

In one example aspect, the present disclosure provides example non-transitory computer readable media storing instructions that are executable by one or more processors to cause a computing system to perform one or more operations of any one or more implementations of the first example computer-implemented method or the second example computer-implemented method or the third example computer-implemented method.

In one example aspect, the present disclosure provides a first example computing system including one or more processors and the example non-transitory computer readable media.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of aspects of an example system for using temporal features according to example aspects of the present disclosure.

FIG. 2 is a block diagram of aspects of an example system for using temporal features according to example aspects of the present disclosure.

FIG. 3 is a block diagram of aspects of an example system for using temporal features according to example aspects of the present disclosure.

FIG. 4 is a block diagram of aspects of an example system for using temporal features according to example aspects of the present disclosure.

FIG. 5 is a block diagram of aspects of an example system for using temporal features according to example aspects of the present disclosure.

FIG. 6 is a block diagram of aspects of an example system for using temporal features according to example aspects of the present disclosure.

FIG. 7 is a flowchart of an example method for training one or more machine-learned models according to aspects of the present disclosure.

FIG. 8 is a block diagram of an example processing flow for using machine-learned model(s) to process input(s) to generate output(s) according to example implementations of aspects of the present disclosure.

FIG. 9 is a block diagram of an example sequence processing model according to example implementations of aspects of the present disclosure.

FIG. 10 is a block diagram of an example technique for populating an example input sequence for processing by a sequence processing model according to example implementations of aspects of the present disclosure.

FIG. 11 is a block diagram of an example model development platform according to example implementations of aspects of the present disclosure.

FIG. 12 is a block diagram of an example training workflow for training a machine-learned model according to example implementations of aspects of the present disclosure.

FIG. 13 is a block diagram of an inference system for operating one or more machine-learned model(s) to perform inference according to example implementations of aspects of the present disclosure.

FIG. 14 is a block diagram of an example networked computing system according to example implementations of aspects of the present disclosure.

FIG. 15 is a block diagram of an example computing device according to example implementations of aspects of the present disclosure.

FIG. 16 is a block diagram of an example computing device according to example implementations of aspects of the present disclosure.

FIG. 17 is a flowchart of an example method according to aspects of the present disclosure.

FIG. 18 is a flowchart of an example method according to aspects of the present disclosure.

FIG. 19 is a flowchart of an example method according to aspects of the present disclosure.

Reference numerals that are repeated across plural figures are intended to identify the same features in various implementations.

### DETAILED DESCRIPTION

Example implementations of the present disclosure provide techniques for training machine-learned models with temporal conditioning for time-aware inference. A machine-learned model can generate query responses that are based on and reflect information contained in a corpus of training content used to train the machine-learned model. The corpus of training content can include information on certain topics that changed over time. The corpus of training content can include training examples representing the information before and after the change. Example techniques according to the present disclosure use temporal conditioning during training so that, at inference time, the trained models can generate query responses that resolve or otherwise reflect that change over time.

For example, the training corpus can include large volumes of information, some of which may contain different descriptions of the same subject. Some of the different descriptions may simply represent diverse viewpoints on the subject. Some of the different descriptions may reflect how the state of the art evolves and updates over time. For example, new scientific discoveries can reveal gaps or misconceptions in previously accepted theories. Current news articles can correct or clarify prior releases. A manuscript can be revised over a series of multiple revisions to correct details, add new results, provide additional context, etc.

Example techniques according to the present disclosure can use temporal features to condition the processing of such training examples to facilitate time-aware inference. The temporal features can be explicit or implicit. Explicit temporal features can include dates, timestamps, revision numbers, etc. that are present in the training inputs (e.g., injecting dates in a training input) or outputs (e.g., inducing the model to regress a date for a given input). Implicit temporal features can include an ordering of training examples such that any training effect from training on less recent training data can be tempered by subsequently training on more recent training data.

Example implementations of the present disclosure can provide a number of technical improvements to machine-learned model inference and training systems as well as advance the field of machine learning and artificial intelligence. In an aspect, machine-learned training systems can be improved. For example, training a machine-learned model using temporal features according to the present disclosure can provide inductive priors that simplify the task of learning a decision boundary for generating content regarding various subjects. For instance, in the absence of structured temporal features in training, with only latent contextual cues a model may need to be subjected to many epochs of training in order to converge on parameter values that correctly discern a decision boundary that distinguishes between stale and current information. In this manner, for instance, training a machine-learned model trained according to aspects of the present disclosure can be more energy and data-efficient.

In an aspect, machine-learned inference systems can be improved. For example, in some cases, without temporal features providing those inductive priors, such nuanced discrimination may only be attainable by using higher parameter counts or higher-bitwidth parameter values. In contrast, by providing structured temporal features in training, the trained model can more effectively use a given number of parameters to model the decision boundary. In this manner, for instance, a machine-learned model trained according to aspects of the present disclosure can be more parameter-efficient. As such, a model with a given functionality can potentially be executed using less storage, less memory, fewer FLOPs, etc.

In an aspect, the technical fields of machine learning and artificial intelligence can be advanced. An outstanding challenge in the field is hallucination, or the generation of content that is not grounded in high-quality (correct) data used to train the model. By disaggregating the temporal dimension of otherwise confounding training examples according to example implementations of the present disclosure, the presently disclosed techniques provide novel data structures (e.g., training inputs and outputs) and losses for training techniques that can help reduce or mitigate model hallucination. These techniques can provide benefits across a wide variety of models, benefiting and advancing the field as a whole.

Similarly, an outstanding challenge in the field is energy consumption. Large machine-learned models can use large numbers of parameters. At rest the parameters can be associated with energy expenditures to maintain the parameters in memory. Further, during training, each round of parameter updates can involve a high number of FLOPs, which can consume energy for processing. As such, reducing a parameter count or reducing FLOPs in training can reduce an energy expenditure. Example implementations of the present disclosure can provide for decreasing a number of FLOPs (e.g., by avoiding additional epochs of training) or a number of parameters (e.g., by providing inductive priors that reduce a demand on the model's expressivity).

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Example implementations of the present disclosure are described in more detail herein with respect to the enclosed figures.

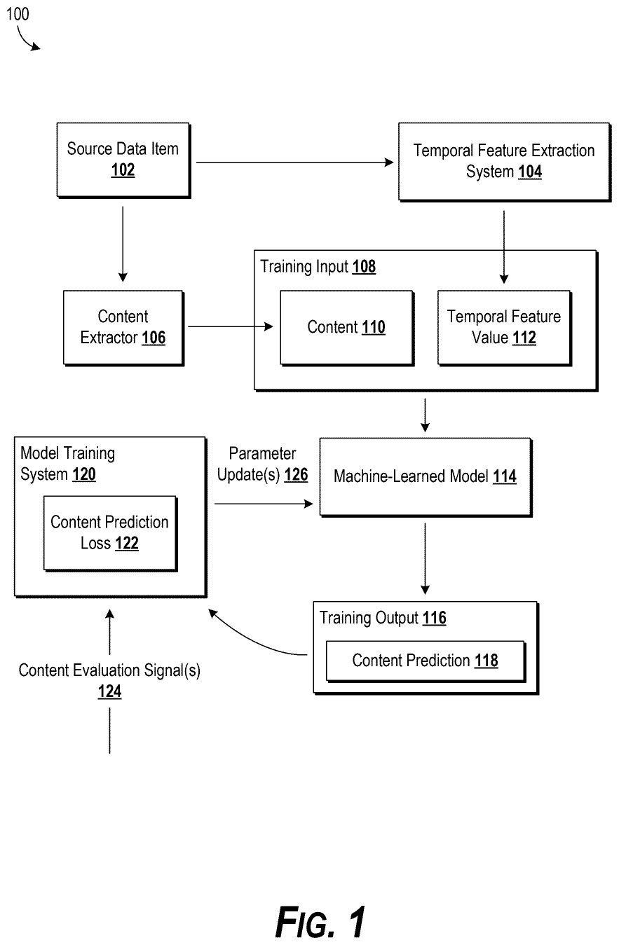

FIG. 1 is a block diagram of a system 100 for training machine-learned models according to example aspects of the present disclosure. System 100 can obtain a source data item 102. Source data item 102 can be processed by temporal feature extraction system 104 and content extractor 106 to obtain training input 108. For example, training input 108 can include content 110 extracted by content extractor 106. Training input 108 can include temporal feature value 112 extracted by temporal feature extraction system 104. Training input 108 can be provided to machine-learned model 114. Machine-learned model 114 can process training input 108 to generate training output 116. Training output 116 can include a content prediction 118. Model training system 120 can compute a content prediction loss 122 based on content prediction 118. Model training system 120 can compute content prediction loss 122 based on evaluation signal(s) 124. Based on content prediction loss 122, model training system 120 can compute parameter update(s) 126 for updating one or more trainable parameters of machine-learned model 114.

Source data item 102 can include any suitable data item. Source data item 102 can include an individual item of content, a plurality of items of content, a corpus of content, etc. Source data item 102 can include text, images, video, audio, sensor data, or combinations thereof. Source data item 102 can include a single data modality or multiple data modalities interleaved together or separately grouped.

Source data item 102 can be obtained from a publicly available training database (e.g., a training database standardized for benchmarking performance of machine-learned models, a public domain training database curated for advancing state of the art performance of machine-learned models) or a privately maintained training database (e.g., a corpus of a user's own documents for personalizing, with the user's approval, a performance of machine-learned models on the user's devices, a corpus of a company's technical documentation to improve a performance of internal machine-learned toolkits). In general, source data item 102 can be obtained with permissions for access for training a machine-learned model.

In an example, source data item 102 can include text data. Example textual documents include articles, books, blogs, research papers, archived libraries of web content, etc. Such documents can provide diverse information across different time periods. These text documents may contain explicit dates such as publication or last-modified dates, or implicit temporal indicators such as references to specific events or technological advancements. Text data can include natural language data, coding language data, structured data representations (e.g., JSON, markup languages), or other data representations using textual characters.

In another example, source data item 102 can include image data (e.g., single frames or multiple frames, such as in video data). Image data can include photographs, illustrations, and other visual content. Image data can reflect visual documentation of time-varying information, such as changes in fashion, architecture, or geographical transformations captured in satellite images.

In another example, source data item 102 can include audio data. Audio data can include recordings of speeches, music, ambient sounds, and other auditory content. Similar to text and image data, audio data can reflect changes over time, such as evolving music genres or changes in language usage and accents.

In another example, source data item 102 can include multimedia content that combines text, images, audio, and other modalities. Each modality can reflect different information from different times. For example, a news article can include a historical image with commentary written for the present day.

Temporal feature extraction system 104 can be or include one or more devices, services, routines, or other processing components configured to process data from source data item 102 and output an extracted temporal feature value 112. Temporal feature extraction system 104 can include one or more machine-learned models or heuristic logic configured to recognize temporal information and output desired temporal feature values.

For example, temporal feature extraction system 104 can parse text to extract explicit dates in the text. Various methods can include regular expressions (regex) and machine-learned natural language processing (NLP) techniques. For instance, regex can detect patterns typically associated with dates, such as “MM/DD/YYYY” or “Month Day, Year,” or ISO formats such as “YYYY-MMM-DD.” These patterns can be applied to the text to locate and extract date strings, which may then be converted into standardized temporal feature values. NLP techniques such as named entity recognition (NER) can be used to detect dates within unstructured text. For instance, NER models can be trained to recognize temporal entities (e.g., “creation date,” “publication date,” etc.). Temporal feature extraction system 104 can extract dates from the primary content of a document or document annotation or metadata. For instance, document titles, document contents, version numbers, revision history data, release notes, document or file headers, timestamps in logged data, etc. can provide temporal information. For example, a document titled “Annual Report 2020” or a file with a version number “v2.3.1 (2021 Apr. 15)” can be parsed to extract the relevant dates. Similarly, revision history data and release notes can contain timestamps indicating when specific changes were made, which can be extracted and used as temporal features for the designated changed portions.

Temporal feature extraction system 104 can process non-text modalities. Temporal feature extraction system 104 can parse image, audio, or video content to extract dates explicitly depicted or described in the content. For instance, Optical Character Recognition (OCR) can be applied to analyze image or video frames to detect and output text within images or videos. This text can then be parsed as described above. This can be used for extracting dates from scanned documents, photos that contain clocks, calendars, signs, or other temporal signals, etc. Similarly, Automated Speech Recognition (ASR) models can convert audio content into text. ASR models can process audio recordings or the audio tracks of video content to transcribe spoken words into text. This transcription can then be analyzed to identify and extract temporal information such as dates mentioned in the dialogue. For example, an ASR model can transcribe a news broadcast, allowing the temporal feature extraction system 104 to identify and extract the date the news was reported.

Temporal feature extraction system 104 may be designed to process various text or non-text modalities and directly output temporal feature values without the need for an intermediate transcription to text. For instance, a pretrained sequence processing model (e.g., a Large Language Model or “LLM,” a Small Language Model or “SLM”, etc.) can be employed to ingest different types of content, whether textual, image-based, video-based, or a mixture thereof. The model can embed this content into a latent embedding space to jointly reason over the input data. The model can generate output values that indicate temporal feature values. For instance, the model may autoregressively generate tokens that form a timestamp or date, providing a precise indication of when the content was created or last modified. The model may include an output head specifically designed to regress date values directly. This output head can be a specialized layer in the neural network that takes the latent embeddings as input and outputs a continuous value representing a date value. The regression output head can be trained to minimize the difference between the predicted date and an actual date.

Temporal feature extraction system 104 can process metadata associated with source data item 102 to extract relevant temporal feature values. Metadata can include data that provides information about source data item 102 while not being included in a primary content portion of source data item 102. For instance, when source data item 102 contains an image, temporal feature extraction system 104 can process EXIF (Exchangeable Image File Format) data, which may contain timestamps indicating when the image was taken, modified, or accessed. In the case of text documents, temporal feature extraction system 104 can process file metadata, which may include creation dates, modification dates, and access dates. Such metadata can be embedded within the file system or within the document itself. For example, a PDF document might contain embedded metadata that specifies the publication date or the last modification date. Similarly, word processing documents can contain metadata fields that record when the document was created and last edited. These timestamps can be extracted and used as temporal feature values 112. Temporal feature extraction system 104 can also process embedded document data, which may include metadata fields within the document itself. For example, research articles and academic papers can include publication dates, revision dates, and submission dates on a portion of one or more of the pages of the document itself (e.g., a margin, a header, a postscript, etc.). The system can parse these dates to extract relevant temporal information. Additionally, web pages may contain meta tags within the HTML that specify the date of publication or last update. These meta tags can be parsed to obtain temporal feature values. Similarly, digital signatures can include timestamps that indicate when the document was signed. These timestamps can be particularly relevant for legal documents or contracts, where the timing of the signature can be informative. Temporal feature extraction system 104 can identify and extract these timestamps to be used as temporal feature values 112.

Source data items 102 and corresponding metadata can provide or contain multiple different temporal feature signals. Temporal feature extraction system 104 can be trained to extract a relevant date for a given task. The relevant date for a given task can be attached to training examples for that task. For instance, consider a hypothetical metadata object for a fictional article:

```
  {
    “id”: 1234,
    “source_type”: “original”,
    “content_type”: “article”,
    “date_created”: “2024-03-15”,
    “citation_data”: {
      “title”: Review of Natural Language Processing Architectures Prior
to the Transformer”,
      “author”: “Doe, J.”,
      “year”: “2018”,
      “uri”: “https://www.arxiv.org/abs/2000.01010”
    }
  }
```

The metadata can contain a creation date for the article. The metadata can contain a publication year for the article (“2018”). But the article content—signaled in the title—can relate to material pre-2017, as the named “Transformer” for a machine-learning architecture is generally attributed to a Jun. 12, 2017, publication by Vaswani et al. Temporal feature extraction system 104 can be trained to focus on the temporal features most relevant to dating the content for a particular task. For instance, for completing a question-answering task for accessing current information on natural language processing architectures, the relevant date might be “2017,” as the methods described in the article may only cover state of the art up to 2017. For completing a question-answering task for accessing current information on studies that analyze natural language processing architectures, the relevant date might be “2018,” as the analysis was performed in 2018. For completing a task evaluating material that is the subject of current interest, the relevant date might be “2024 Mar. 15,” as the creation date may signify when the document file was downloaded or saved by a user. For completing a task regarding linear algebra in the context of machine learning, the date may not be relevant, as the correctness of the mathematical statements may be time invariant.

Temporal feature extraction system 104 can include machine-learned models that may be trained to infer temporal feature values based on implicit aspects of the content. Temporal feature extraction can be generally based on latent feature extraction and classification learned during training. For instance, a classification model may be trained to classify the date associated with the content. The classification model can be designed to predict general time periods (e.g., decades, years) or specific dates based on the latent features extracted from the content. These latent features can be based on aspects of the content that are indirectly indicative of its temporal context, such as the language style, specific terms used or referenced objects or events. During training, the model can learn to associate these latent features with specific time periods.

Temporal feature extraction system 104 can extract a relevant date for a training example based on a task associated with the training example. A task indicator can condition the inference of temporal feature extraction system 104. Temporal feature extraction system 104 can infer a list of likely tasks for which a given source data item may be used and infer dates (or null values) from the source data item relevant to each task.

Another temporal feature extraction approach can include retrieval-augmented generation. For example, the system can compile a query from data present in the content, such as events, people, products, objects, etc. referenced within the text. For instance, if the content mentions a historical event or a recent scientific discovery, the system can generate a query that captures these references. The system can generate the query using a machine-learned sequence processing model trained to generate textual queries based on input content. This query can then be executed against a database, knowledge graph, or other information repository using a search engine to retrieve date information corresponding to the mentioned events. Based on the search results, the system can generate a temporal feature value that may be indicative of the time period during which the content was relevant or created. The system can generate the temporal feature value using a machine-learned sequence processing model trained to generate temporal feature values based on input data.

Another temporal feature extraction approach can include using explicit comparisons to other content. For example, similarity search techniques can be used to identify similar content with known temporal information. By comparing the source data item to these similar examples, the system can infer a temporal feature value. For example, if the source data item discusses a particular event or object, the system can find other documents discussing the same information and use their timestamps to approximate the temporal feature value for the source data item.

Temporal feature extraction system 104 may incorporate machine-learned models specifically trained to identify and extract date information relevant to dating one or more source data items or different parts of a source data item. For example, in the case of a news article that includes a historical image accompanied by present-day commentary, the system may need to discern multiple temporal features. The article itself may typically be associated with its publication date, which serves as the primary temporal feature for the overall document. However, the historical image embedded within the article may be associated with a different temporal feature, specifically the date when the image was originally captured. Additionally, any factual description of the image may also be tied to this historical date, while the commentary on the image may be more appropriately associated with the article's publication date. For example, factual description of the image, such as details about the event or individuals depicted, can be associated with the historical date when the image was captured. The machine-learned model can process the text and identify references that pertain specifically to the image and distinguish them from the rest of the article. The machine-learned model can process the text and identify commentary on the image, which may likely be written in the present day and reflect a current perspective or analysis, and associate that content with the publication date of the article.

To achieve this level of granularity, temporal feature extraction system 104 may implement machine-learned models that have been trained on a diverse set of annotated documents. These models may be trained to recognize contextual cues and metadata that indicate the temporal relevance of different parts of a document. The training process for these machine-learned models may involve supervised learning techniques where the models are exposed to large datasets containing documents with annotated temporal features. During training, the models may learn to associate specific types of content with their respective dates. For example, the model may learn that an image caption often includes a historical date, while the surrounding text may relate to the current publication date. Once trained, these models may be integrated into temporal feature extraction system 104. Returning to the news article example, the system may first identify the publication date using metadata or contextual analysis. It may then proceed to analyze embedded elements like images, extracting historical dates from captions or associated metadata. The system may also differentiate between factual descriptions and commentary, assigning appropriate temporal features to each segment.

In an example, the system can output a document-level temporal feature object. For the news article example, a hypothetical simplified object is provided below for the sake of illustrating the broader concepts described herein:

```
  {
    “document_metadata”: {
      “publication_date”: “2023-05-08”,
      “source_url”: “https://example.com/news-article”
    },
    “sections”: [
      {
        “section_id”: “sec1”,
        “section_type”: “text”,
        “content”: “This post commemorates . . .”,
        “temporal_features”: {
          “date_of_origin”: “2023-05-08”,
          “date_of_commentary”: “2023-05-08”
        }
      },
      {
        “section_id”: “sec2”,
        “section_type”: “image”,
        “content”: “https://example.com/image1.jpg”,
        “temporal_features”: {
          “date_of_origin”: “1945-05-08”,
          “date_of_commentary”: “2023-05-08”
        }
      },
      {
        “section_id”: “sec3”,
        “section_type”: “text”,
        “content”: “The image above, captured on VE Day in 1945,
shows . . .”,
        “temporal_features”: {
          “date_of_origin”: “1945-05-08”,
          “date_of_commentary”: “2023-05-08”
        }
      },
      {
        “section_id”: “sec4”,
        “section_type”: “text”,
        “content”: “The significance of VE Day in today's context . . .”,
        “temporal_features”: {
          “date_of_origin”: “2023-05-08”,
          “date_of_commentary”: “2023-05-08”
        }
      }
    ]
  }
```

Content extractor 106 can be or include one or more devices, services, routines, or other processing components configured to select or generate a portion of content for a training example for training a machine-learned model. Content extractor 106 can operate by parsing source data item 102 to identify relevant portions of content that can be used as training inputs.

Content extractor 106 can extract all the content of source data item 102 for creating a training example. Content extractor 106 can divide source data item 102 into chunks or segments to create one or multiple training examples from a given source data item.

Content extractor 106 can divide source data item 102 into chunks or segments using various techniques based on the data type involved. For text data, content extractor 106 can break down documents into smaller units such as chapters, sections, paragraphs, sentences, etc. This segmentation can be achieved through heuristic-based rules, machine-learned models, or a hybrid approach. For instance, heuristic-based rules may involve identifying sentence boundaries using punctuation marks and whitespace, while machine-learned models such as natural language processing (NLP) models can be employed to detect sentence boundaries more accurately by understanding the linguistic context. These NLP models can be trained on large corpora of text to recognize the structure and semantics of sentences, thereby providing more precise segmentation.

For image data, content extractor 106 can segment the content into regions of interest or extract frames from a video. This can include the use of computer vision models that are capable of identifying objects, faces, or other significant features within an image. These models can be trained on annotated datasets containing images with labeled objects, enabling them to learn to recognize and segment various objects accurately. For video data, content extractor 106 can use techniques such as keyframe extraction to identify and extract frames that represent significant changes or events within the video, thereby reducing the data size while retaining the most relevant information.

For audio data, content extractor 106 can segment the content into time intervals or phonetic units. This can be achieved using techniques such as voice activity detection (VAD) to identify segments of speech within an audio recording. VAD algorithms can analyze the audio signal to detect periods of silence and speech, allowing the system to segment the audio into meaningful chunks. Additionally, machine-learned models such as automatic speech recognition (ASR) systems can be used to transcribe the audio into text, which can then be further segmented into phonetic units or words. These ASR systems can be trained on large datasets of audio recordings and their corresponding transcriptions, enabling them to accurately recognize and segment speech.

Once content extractor 106 has divided source data item 102 into chunks or segments, each chunk can be used to generate training examples. Each chunk can inherit a temporal feature value from the data from which it was chunked. For instance, if a text document is segmented into sentences, and the document itself has a global temporal feature value, each sentence chunk can inherit the temporal feature value associated with the original document. If the document has multiple temporal feature values for different sections, the respective chunks can inherit a temporal feature value from a corresponding chunk.

Generating training examples for each chunk can include creating a structured pairing that indicates the content of the chunk and its associated temporal feature value. For example, a training example for a text chunk can include the sentence text along with the date of publication. This can be represented as a structured input where the sentence text is concatenated with the temporal feature value, forming a single input sequence for the machine-learned model. Similarly, for image data, a training example can include the segmented region of interest along with the timestamp indicating when the image was captured. For audio data, a training example can include the segmented audio clip along with the temporal feature value representing the recording date.

To illustrate, consider a text document segmented into paragraphs. Each chunk can be paired with the temporal feature value of the document, resulting in training examples such as:
{“content”: “Current leading approaches for computing approximate solutions to complex ODEs . . . ”, “temporal_feature”: “2023 May 8”}
{“content”: “Finite element analysis systems often employ . . . ”, “temporal_feature”: “2023 May 8”}

For image data, the training examples can include segmented regions of interest with their associated timestamps:
{“content”: “image_segment_1.jpg”, “temporal_feature”: “2021 Apr. 15”}
{“content”: “image_segment_2.jpg”, “temporal_feature”: “2021 Apr. 15”}

For audio data, the training examples can include segmented audio clips with their recording dates:
{“content”: “audio_clip_1.wav”, “temporal_feature”: “2022 Sep. 10”}
{“content”: “audio_clip_2.wav”, “temporal_feature”: “2022 Sep. 10”}

Content extractor 106 can generate synthetic content for training examples. This can reduce a size of a training dataset (e.g., by summarizing long-form content) or enhance the diversity and robustness of the training dataset. Content extractor 106 can condense longer segments of text into shorter, more concise summaries. Summarization can be performed using extractive or abstractive techniques. Extractive summarization may include selecting key sentences or phrases directly from the original content, whereas abstractive summarization may include rephrasing and paraphrasing the original text to generate a more coherent and succinct summary. For instance, an extractive summarization model can be trained on annotated datasets where important sentences are labeled, enabling it to identify and extract these sentences from new documents. An abstractive summarization model can be trained using sequence-to-sequence learning, where the input sequence is the original text and the output sequence is the human-written summary. The model learns to generate new sentences that capture the essence of the original text.

Content extractor 106 can generate descriptive text for images or video frames. Image captioning models can be trained on datasets containing images paired with descriptive sentences. The captioning model can be trained to minimize the difference between a generated caption and a ground truth caption. This technique can be extended to video captioning, where the model generates descriptions for individual frames or sequences of frames. By generating captions, content extractor 106 can create training examples that pair visual content with descriptive text, enriching the training dataset for multimodal machine-learned models.

In general, content extractor 106 can perform data augmentation. Data augmentation can include creating variations of the original content to associate with an existing label (e.g., the temporal feature value) to increase the diversity of the training dataset without collecting new data. For text data, data augmentation techniques can include text replacement, text rephrasing (e.g., using a machine-learned model to generate a rephrased version), etc. For image data, data augmentation can involve transformations such as rotation, scaling, cropping, flipping, and color adjustments. For instance, an image can be rotated by a random angle, scaled up or down, cropped to focus on different regions, flipped horizontally or vertically, or have its brightness, contrast, and saturation adjusted. Similarly, for audio data, data augmentation can include techniques such as time-stretching, pitch-shifting, adding background noise, and applying filters. For example, an audio clip can be time-stretched to play faster or slower, pitch-shifted to alter the frequency, or mixed with background noise to simulate different recording environments.

Training input 108 may be formatted differently depending on the type of model being used. For instance, for text-only models, the training input can be a string that includes both the document text and the associated date. This string may be structured in a standardized format or schema to ensure the model can effectively parse and utilize the temporal information. For example, the input string might be formatted as follows: “Document Text: [document_text] Date: [date]”.

For multimodal models, training input 108 can leverage multiple interfaces to handle different data types. In such cases, the temporal information (e.g., a date string) may be fed into a text interface (e.g., a text encoder, text tokenizer), while the primary content (e.g., an image) may be input to an image interface (e.g., an image encoder, image tokenizer).

For image-only models, the temporal information may be embedded directly into the image data. This can be achieved by rasterizing the date string and compositing it over the image. The timestamp may be placed in a consistent location, such as the bottom-right corner, and rendered in a legible font and size to ensure it is easily readable. For instance, the date “2023 May 8” could be rasterized and overlaid on the image, creating a composite image that includes both the visual content and the temporal information.

For audio models, one approach may involve generating a spectrogram of the audio file and then rasterizing and compositing a timestamp over the spectrogram image. For instance, an audio recording from “2023 May 8” may be converted into a spectrogram, with the date “2023 May 8” overlaid in a corner of the spectrogram image. This visual representation of the audio, combined with the temporal information, can be fed into models designed to process image-like data. Another approach for audio models may be to concatenate the original audio file with a synthetic audio file that contains a verbalized timestamp. For example, an audio recording might be followed by a synthetic voice stating, “This recording was made on May 8, 2023.” The verbalized timestamp can provide the model with explicit temporal context.

Content 110 can include an item of content extracted by content extractor 106. Content 110 can include various different data modalities.

Temporal feature value 112 can include various forms of temporal information output by temporal feature extraction system 104. Temporal feature value 112 can include a specific time, which may be represented as a timestamp. This timestamp can be in a variety of formats, such as Unix epoch time, which counts the number of seconds that have elapsed since Jan. 1, 1970 (UTC), or more human-readable formats like ISO 8601, which may include date components (e.g., “2023 Oct. 15”), time components (e.g., “14:30:00Z”), or both date and time components (e.g., “2023-10-15T14:30:00Z”).

Temporal feature value 112 can generally include a date. This date can be as granular as a specific day (e.g., “2023 Oct. 15”) or can be less granular, such as a month and year (e.g., “October 2023”) or just a year (e.g., “2023”). The granularity of the date can be determined based on the source data item and the requirements of the machine-learned model. For instance, a news article may include an exact publication date, whereas a historical document may only include a year.

Temporal feature value 112 can include a date range, such as for content that spans a broader period. For example, a date range might indicate a decade (e.g., “1990s”) or a century (e.g., “20th century”). This type of temporal feature can be used, for example, for data for which exact dates may not be available or necessary.

Temporal feature value 112 can include one or multiple time or date values that indicate different temporal features associated with a given portion of content. In an example, a temporal feature value can include information origin and information publication dates. Information origin can refer to an estimated initial time when the content or its underlying data was first created, discovered, or recorded. For instance, in the case of a scientific research paper, the information origin date may be the date when the primary experiments were conducted or when the initial draft of the manuscript was completed. Information publication can refer to an estimated date when the content was made publicly available, such as the publication date of a journal article, the release date of a news article, or the upload date of a blog post.

Temporal feature value 112 may include one or both the information origin and information publication dates. Dual temporal annotation can provide additional contextual signals to the model in scenarios where the creation and publication dates differ significantly.

Machine-learned model 114 can be a machine-learned model that is the subject of one or more training cycles (e.g., an “in-training” machine-learned model). Machine-learned model 114 can include various different types of machine-learned model architectures. Example machine-learned models are described below with respect to machine-learned model 1. In general, machine-learned model 114 can process training input 108 and generate training output 116.

Training output 116 can be generated by machine-learned model 114 after processing training input 108. Training output 116 can include various forms of predictions or inferences, depending on the specific configuration of machine-learned model 114. In the context of the present disclosure, training output 116 can include content predictions 118.

Content prediction 118 can include one or more predictions generated based on content 110 in view of temporal feature values 112.

For example, content prediction 118 may include one or more predictions over a vocabulary of tokens. For example, for a given token position in a sequence, machine-learned model 114 can generate a probability distribution over a token vocabulary, conditioned on preceding tokens (e.g., causal language modeling) or preceding and following tokens (e.g., bidirectional language modeling). The model can be evaluated by comparing the predicted distribution to the actual token value at that location (e.g., using a negative log likelihood loss). For instance, an “actual” distribution can be a one-hot vector over the token vocabulary that indicates the “true” token at that location.

Content prediction 118 may include a sequence of tokens representing the next word or phrase in a given context. The predicted tokens can be compared to reference tokens in the training data (e.g., an input/output pair), using metrics such as cross-entropy loss. Evaluation signal(s) 124, which may include ground truth labels or reference sequences, can provide the reference data for loss computation.

In general, content prediction 118 may include a classification output (e.g., for image classification), image patch output (e.g., for object detection), image output (e.g., for image generation), text output (e.g., for text generation or translation), audio output (e.g., for speech synthesis), or any other suitable type of output that the machine-learned model is configured to generate. Each type of output may be generated based on the specific training objectives and the nature of the input data.

In an example, content prediction 118 can include one or more predictions generated based on content 110 in view of temporal feature values 112. Content prediction 118 can include generated content that aligns with the temporal context provided by temporal feature values 112. For instance, in the case of a next-token prediction, the machine-learned model 114 may process content 110 along with temporal feature values 112 to predict the subsequent token in a sequence of text. Temporal feature values 112 can be used to prioritize information retrieval that is temporally relevant to the query.

Model training system 120 can be or include one or more devices, services, routines, or other processing components configured to facilitate the training of machine-learned models. This system may typically be responsible for managing and executing the various stages of the training process. For example, it can handle the ingestion of training data, the computation of losses, and the updating of model parameters. For example, model training system 120 can provide training example 108 as input to machine-learned model 114. Model training system 120 can receive training output 116 as output from machine-learned model 114. Model training system 120 can compute content prediction loss 122 to evaluate content prediction 118.

Content prediction loss 122 may be a metric used to evaluate a quality of the content output by machine-learned model 114 during training. Content prediction loss 122 can include supervised learning losses, unsupervised learning losses, or reinforcement learning losses (e.g., reinforcement learning from human feedback or “RLHF”).

In a supervised learning context, content prediction loss 122 may typically be calculated by comparing the model's predictions against a set of labeled data. This labeled data may include correct responses or outputs that the model is expected to generate. For example, if the model is being trained to predict the next word in a sentence, the labeled data can include the correct sequence of words. The loss function may measure the difference between the predicted output and the actual labeled data, such as by using metrics such as cross-entropy loss. In an example, evaluation signal(s) 124 can include labels or labeled data that operate as reference data for computing content prediction loss 122.

In an unsupervised learning context, content prediction loss 122 may be computed without labeled data. Instead, the model may learn to generate outputs by identifying patterns and structures within the input data itself. For instance, an autoencoder might learn to compress input data into a latent representation and then reconstruct the original data from this representation. The loss function may measure the difference between the original input and the reconstructed output, guiding the model to improve its ability to capture the underlying data distribution. In an example, a model can be trained to recover values in the input. For instance, masked language modeling can be used to predict portions of an input sequence, with the masked portions operating as a reference or ground truth. In an example, evaluation signal(s) 124 can include original masked data or other self-generated references that operate as reference data for computing content prediction loss 122.

In a reinforcement learning context, evaluation signal(s) 124 can indicate a reward, penalty or other signal from a real or simulated environment engaged using training output 116 from machine-learned model 114. In an example, model training system 120 may receive feedback from human evaluators who rate the quality of the model's predictions. This feedback may be used to compute a reward signal, which model training system 120 can use for computing a loss that can be backpropagated through machine-learned model 114 or otherwise training machine-learned model 114. For example, if the model generates a response to a query, human evaluators can rate the response based on its relevance, accuracy, and coherence. The rating can be input as quantified (e.g., numerically) or provided as textual feedback that is ingested by a reward estimation model that outputs a regressed quantity indicating a reward value.

Parameter update(s) 126 can include one or more parameter value changes to learnable parameters of machine-learned model 114. For example, model training system 120 can backpropagate a loss through machine-learned model 114 to compute an estimated effect of changing a particular parameter on the overall loss value (e.g., a gradient of the loss at that parameter). Based on the estimated effect, model training system 120 can generate an update to apply to the value (e.g., a new value, a delta amount to add to the value, or pruning the value).

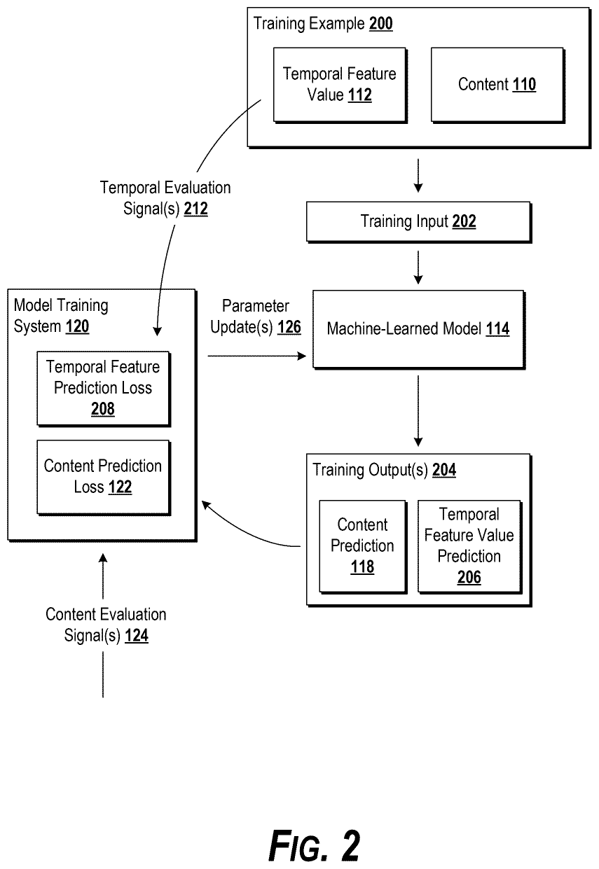

FIG. 2 is a block diagram of an example system for training a machine-learned model to explicitly reason regarding the temporal features of input or generated content. A training example 200 can include content 110 associated with a temporal feature value 112. A training input 202 can be based on training example 200 (e.g., including all or a portion of content 110). Machine-learned model 114 can process training input 202 to generate training output 204. Training output 204 can include temporal feature value prediction 206. Model training system 120 can evaluate temporal feature value prediction 206 using a temporal feature prediction loss 208. Temporal feature prediction loss 208 can be computed based on one or more temporal evaluation signal(s) 212 (e.g., indicating a reference temporal feature value, such as a temporal feature value 112 associated with content 110). Training output 204 can include content prediction 118. Model training system 120 can evaluate content prediction 118 using content prediction loss 122. Model training system 120 can compute content prediction loss 122 based on one or more content evaluation signal(s) 124 (e.g., a reference portion of content 110, a reward signal, etc.). In this manner, for example, machine-learned model 114 can be trained to explicitly predict temporal feature values regarding the temporal features of input or generated content. This can cause machine-learned model 114 to learn to recognize temporal features of inputs and outputs from the model. This temporal awareness can condition the model to prioritize temporally relevant information for a given prediction task.

Training example 200 can include a pairing of content with temporal feature values thereof. The temporal feature values can be obtained as described above with respect to FIG. 1.

Training input 202 can be obtained based on training example 200. Training input 202 can include content from content 110. Explicit temporal feature values can be omitted from or masked out of training input 202 so that machine-learned model 114 can learn to predict the temporal feature values. Explicit temporal feature values can be included in training input 202 (e.g., multiple different temporal feature values) so that machine-learned model 114 can learn to select a relevant temporal feature value based on a current task.

Training output 204 can include content generated by machine-learned model 114. Training output 204 can include a content prediction (e.g., a classification output, a content generation output, etc.). Training output 204 can include an explicit temporal feature value prediction.

Temporal feature value prediction 206 can include a prediction or estimation of a temporal feature value (e.g., such as temporal feature value 112). Temporal feature value prediction 206 can include a numerical regression of a time or date value. Temporal feature value prediction 206 can include a textual or a tokenized representation of a time or date value (e.g., a sequence of textual tokens autoregressively generated by machine-learned model 114).

Temporal feature prediction loss 208 can include a loss value quantifying a difference between temporal feature value prediction 206 and a reference value indicated by temporal evaluation signal(s) 212. Temporal feature prediction loss 208 can include a loss value quantifying a reward or penalty indicated by temporal evaluation signal(s) 212. For instance, a feedback system can provide an evaluation signal indicating a quality of temporal feature value prediction 206. The feedback system can include a human feedback interface for collecting inputs from users that indicate a perceived quality of temporal feature value prediction 206.

Model training system 120 can generate parameter update(s) 126 based on temporal feature prediction loss 208, content prediction loss 122, or a combination thereof. For instance, a combined loss can be based on both temporal feature prediction loss 208 and content prediction loss 122. A combined loss can include a weighted combination of temporal feature prediction loss 208 and content prediction loss 122.

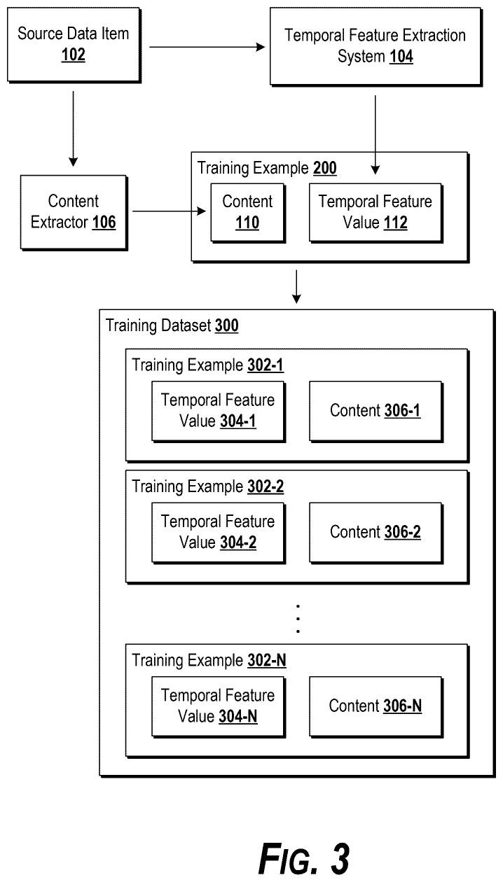

FIG. 3 is a block diagram of an example system for generating a temporally indexed training dataset. Content 110 and temporal feature values 112 can be extracted from one or more source data items 112 as described above with respect to FIGS. 1 and 2. Training examples 200 can be composed based on the extracted data. Training dataset 300 can be populated with training examples 302-1, 302-2, . . . , 302-N. Each training example can associate a temporal feature value (e.g., 304-1, 304-2, . . . , 304-N) with corresponding content (e.g., 306-1, 306-2, . . . , 306-N). Training dataset 300 can be structured to allow retrieval of training examples in a chronological order. Training dataset 300 can itself order training examples based on temporal feature values (e.g., as an ordered list populated in chronological order) or can facilitate querying for and extraction of a chronological ordered set of training examples.

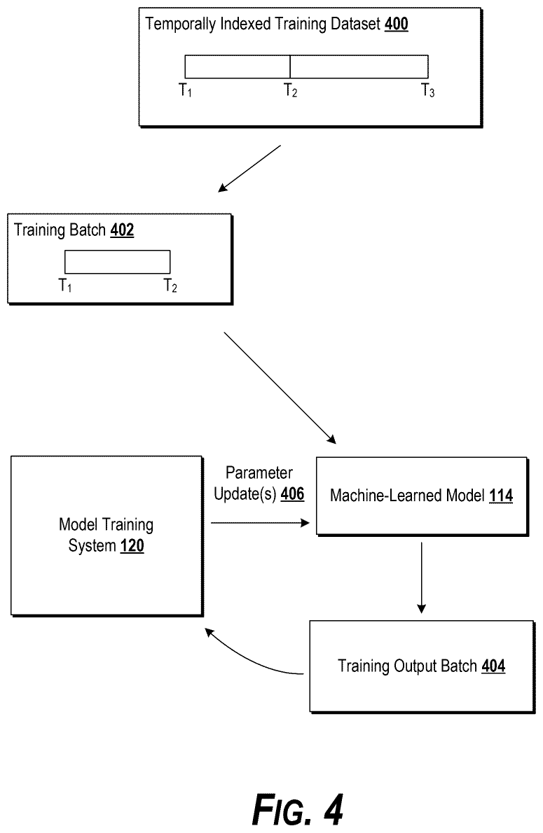

FIG. 4 is a block diagram of an example training cycle using temporally indexed training dataset 400. Training dataset 400 can contain training examples that span a range of temporal feature values. For instance, training dataset 400 can include training examples that cover a range of times from T₁ to T₂ to T₃. A training batch 402 can be constructed (e.g., by sampling from dataset 400) that covers a range of times from T₁ to T₂. Machine-learned model 114 can be trained based on training batch 402. For example, machine-learned model 114 can process training batch 402 to generate training output batch 404. Model training system 120 can compute parameter updates 406 based on evaluating training output batch 404.

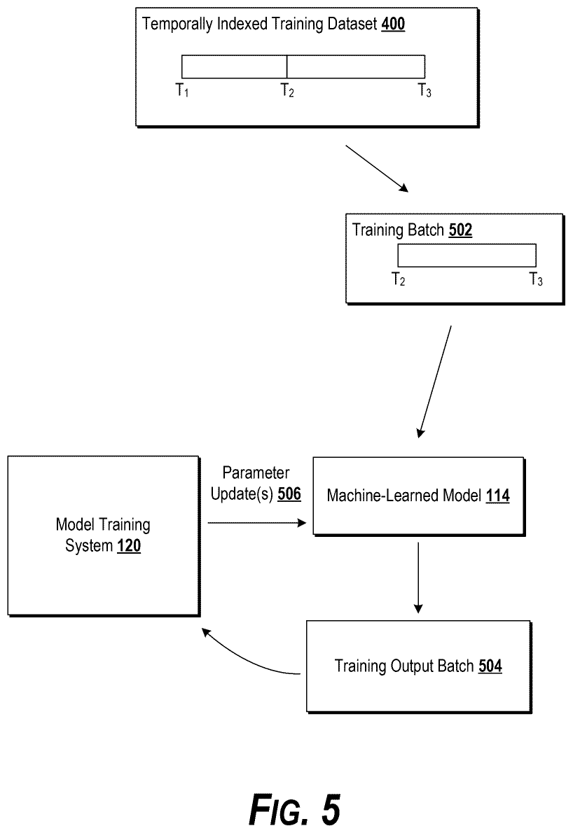

FIG. 5 is a block diagram of another example training cycle using temporally indexed training dataset 400. Another training batch 502 can be constructed (e.g., by sampling from dataset 400) that covers a range of times from T₂ to T₃. Machine-learned model 114 can be trained based on training batch 502. For example, machine-learned model 114 can process training batch 502 to generate training output batch 504. Model training system 120 can compute parameter updates 506 based on evaluating training output batch 504.

In this manner, for instance, a system can provide for training a machine-learned model using the temporally indexed training dataset, wherein successive parameter updates are computed based on chronologically ordered batches of training examples. For instance, by first updating machine-learned model 114 with parameter updates 406 based on data covering a range of times from T₁ to T₂ and then updating machine-learned model 114 with parameter updates 506 based on data covering a range of times from T₂ to T₃, machine-learned model 114 can be trained such that more recent data has a dominant impact on the behavior of the model. In such an example, for instance, a first batch of training examples can include a first plurality of training examples corresponding to a first plurality of temporal features, a second batch of training examples can include a second plurality of training examples corresponding to a second plurality of temporal features, and times indicated by the first plurality of temporal features can chronologically precede times indicated by the second plurality of temporal features.

Chronologically ordered batches of training examples can be functionally chronologically ordered without satisfying strict chronological ordering over all examples. For instance, chronologically ordered batches can include randomly or uniformly distributed training examples that lack temporal feature values.

In an example, chronologically ordered batches can include multiple different chronological ordering tracks that are not globally in strict chronological order but satisfy local chronological ordering within each track.

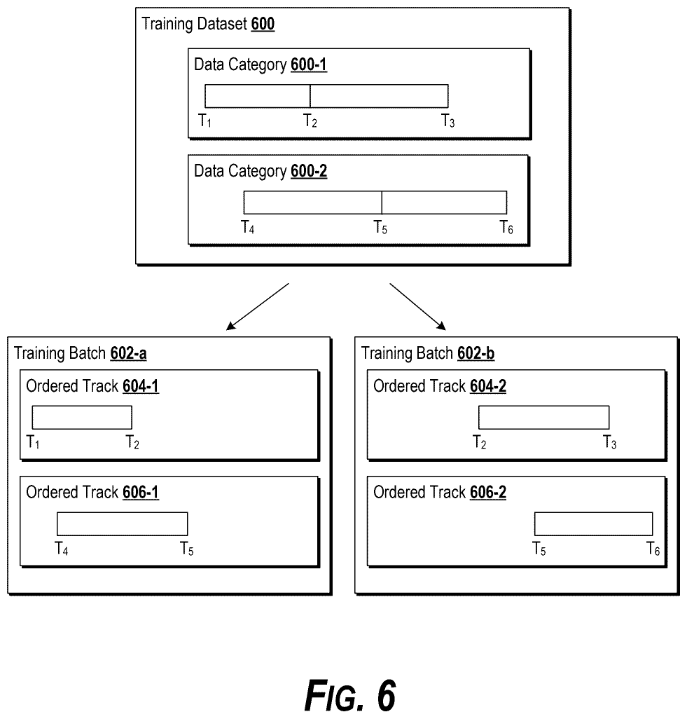

FIG. 6 is a block diagram of a training cycle using training dataset 600. Training dataset 600 can include multiple categories of data, such as data category 600-1 and data category 600-2. Data category 600-1 can include training examples that cover a range of times from T₁ to T₂ to T₃. Data category 600-2 can include training examples that cover a range of times from T₄ to T₅ to T₆. In some examples, T₁<T₄<T₂<T₅<T₃<T₆.

Training batches constructed from dataset 600 can include multiple chronological ordering tracks. Each track can be locally chronologically ordered across successive batches, although the different tracks may not be strictly chronologically ordered across the batches. For instance, a first training batch 602-a can include a first portion of a first ordering track 604-1 that includes a plurality of training examples covering a range of times from T₁ to T₂. First training batch 602-a can include a first portion of a second ordering track 606-1 that includes a plurality of training examples covering a range of times from T₄ to T₅. For instance, a second training batch 602-b can include a second portion of a first ordering track 604-2 that includes a plurality of training examples covering a range of times from T₂ to T₃. This second portion of the first ordering track 604-2 can be chronologically ordered after the first portion of the first ordering track 604-1. Second training batch 602-b can also include a second portion of a second ordering track 606-2 that includes a plurality of training examples covering a range of times from T₅ to T₆. This second portion of the second ordering track 606-2 can be chronologically ordered after the first portion of the second ordering track 606-1. In this manner, for instance, the ordering tracks are locally chronologically ordered, although globally the second training batch can include some examples (e.g., examples in 604-2 for T₂) that are not strictly ordered after some examples in the first training batch (e.g., examples in 606-1 for T₅).

In some instances, the overall chronologically ordering of parameter updates may still be effected in such a configuration when the ordering tracks satisfy an orthogonality measure. For instance, learning a history of botany science in chronological order may be implemented in parallel with learning advances in steel casting techniques from a different time period. Sufficiently orthogonal topics or datatypes can affect different sets of parameters in a model or can affect parameters in sufficiently orthogonal ways such that they can be learned in parallel without effectively disrupting the chronological ordering of parameter updates.

An example orthogonality measure can be based on latent embeddings of training examples. For example, obtaining a cosine similarity between latent embeddings below a threshold similarity can indicate sufficient orthogonality.

An example orthogonality measure can be based on identifying parameters of machine-learned model 114 that are activated by processing different training examples. For instance, a heat map or other activation map can be constructed that indicates a level of activation. An overlap measure (e.g., intersection over union) of the activated parameters below a threshold amount can indicate sufficient orthogonality.

In an example, training machine-learned model 114 using a temporally indexed training dataset, wherein successive parameter updates are computed based on chronologically ordered batches of training examples, can provide a strong training baseline that enables subsequent fine-tuning over time to remain within the overall chronological ordered scheme. For instance, under such an approach, updating the model periodically when new information comes in naturally fits within the same approach, such that successive parameter updates continue to be computed based on chronologically ordered batches of training examples.

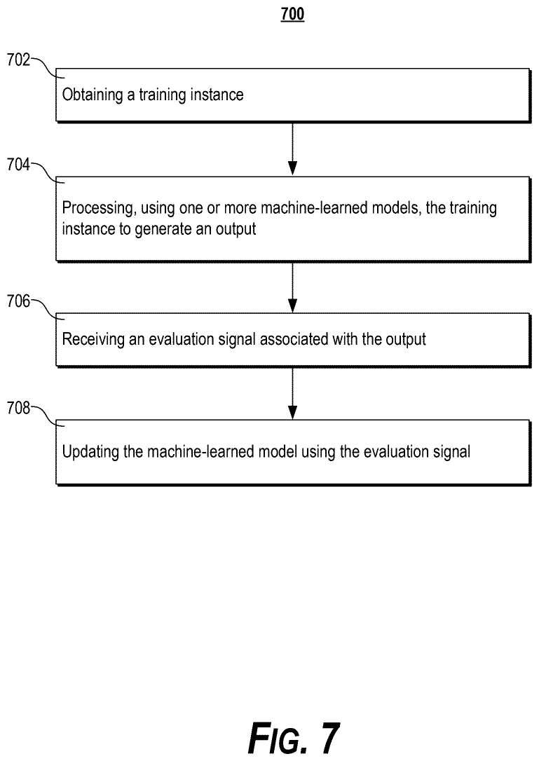

FIG. 7 depicts a flowchart of a method 700 for training one or more machine-learned models according to aspects of the present disclosure. For instance, an example machine-learned model can include one or more machine-learned models used by an encoder operator, one or more machine-learned models used by machine-learned model system 100, one or more machine-learned models used by context selector 300, one or more machine-learned models used by context chunking system 1100, etc.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models. The output can be a final output or an intermediate output (e.g., a logit value associated with a given final output candidate).

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

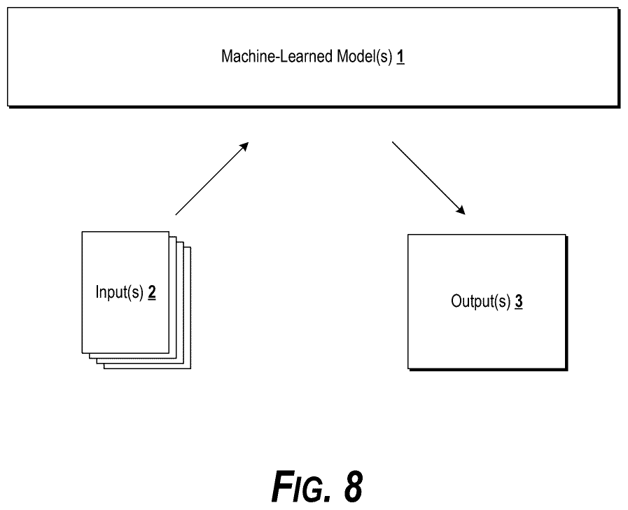

FIG. 8 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., models 106, 402-1, 402-2, etc.). For example, any one or multiple of the following can be a machine-learned model 1: one or more machine-learned models used by an encoder operator, one or more machine-learned models used by machine-learned model system 100, one or more machine-learned models used by context selector 300, one or more machine-learned models used by context chunking system 1100, etc. Features and variations described herein with respect to machine-learned model 1 are to be understood as describing features and variations of any of the machine-learned models described herein. Where this description references machine-learned model 1 it is to be understood that implementations of each of such other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

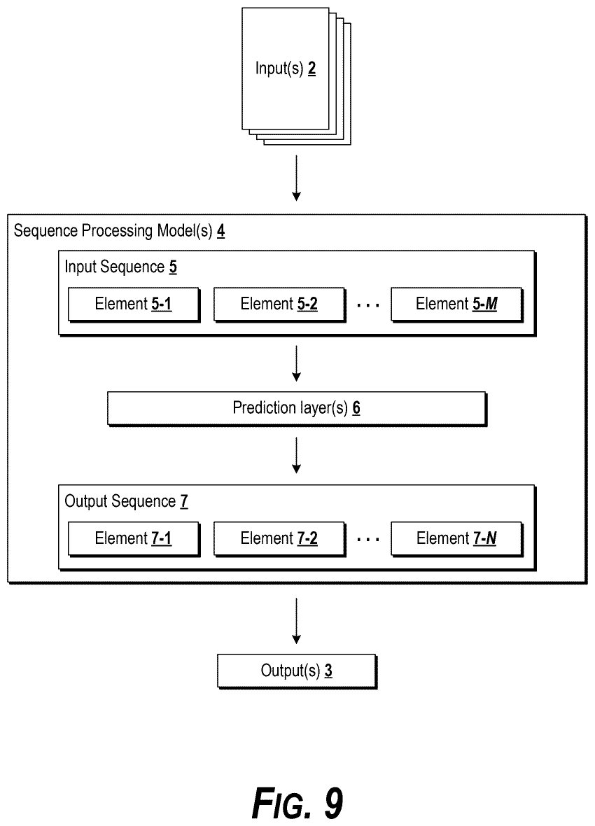

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 23 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

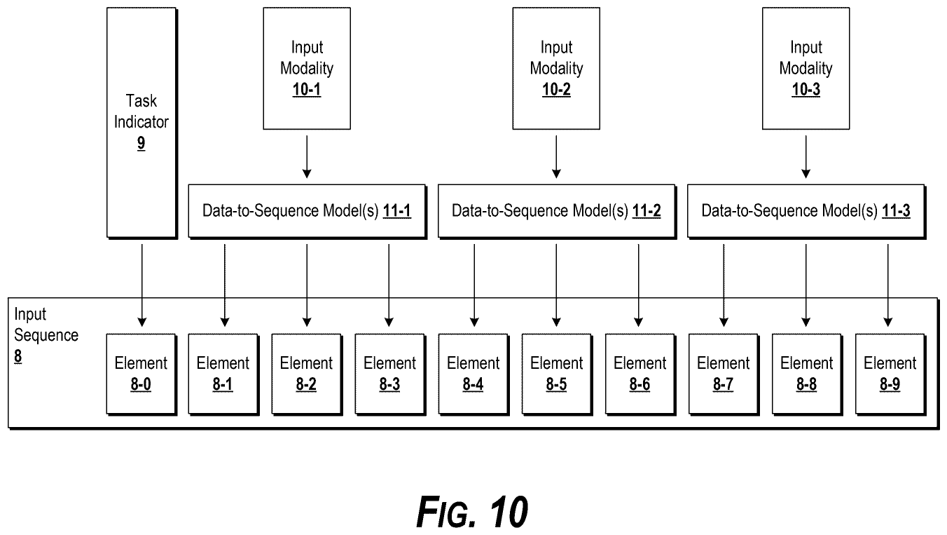

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned value within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

In an example, an input modality corresponds to a context graph modality. For instance, input modality 10-1 can be a context graph that represents a set of context data 106. Data-to-sequence model(s) 11-1 can include one or more encoding models that generate encoded representations for different positions in the context graph. In an example, data-to-sequence model(s) 11-1 generates one element that corresponds to an encoded representation of a portion or the entirety of the context graph. In an example, data-to-sequence model(s) 11-1 generates multiple elements that respectively correspond to encoded representations of respective portions of the context graph. In an example, data-to-sequence model(s) 11-1 generates multiple elements that respectively corresponds to respective encoded representations that collectively represent a portion or the entirety of the context graph.

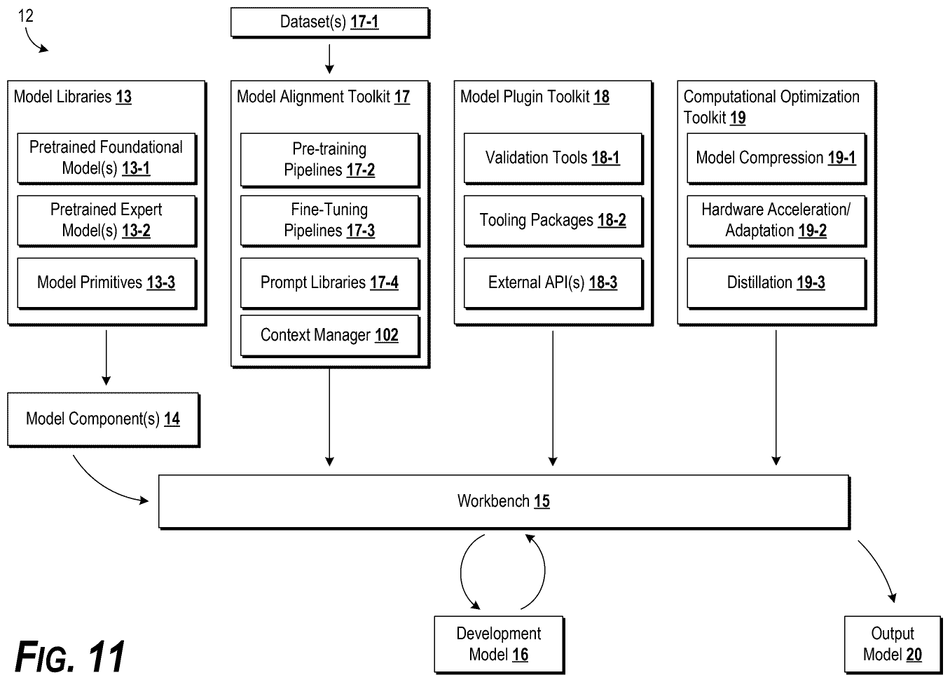

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training methods described herein.

Context manager 102 and corresponding libraries can be provided as a tool for inducing alignment of model outputs over long contexts.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output an instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

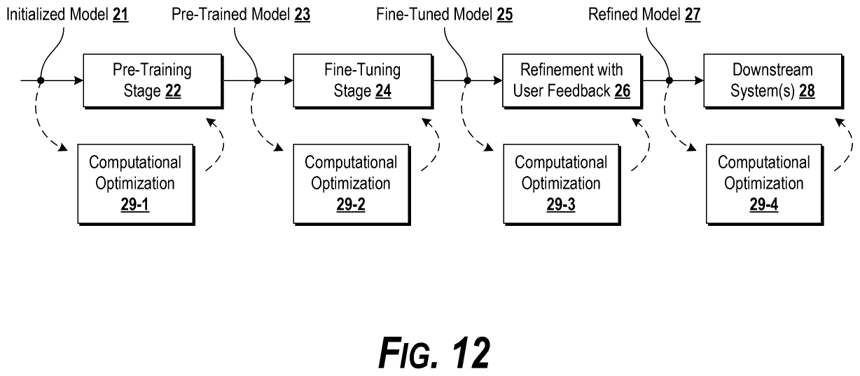

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

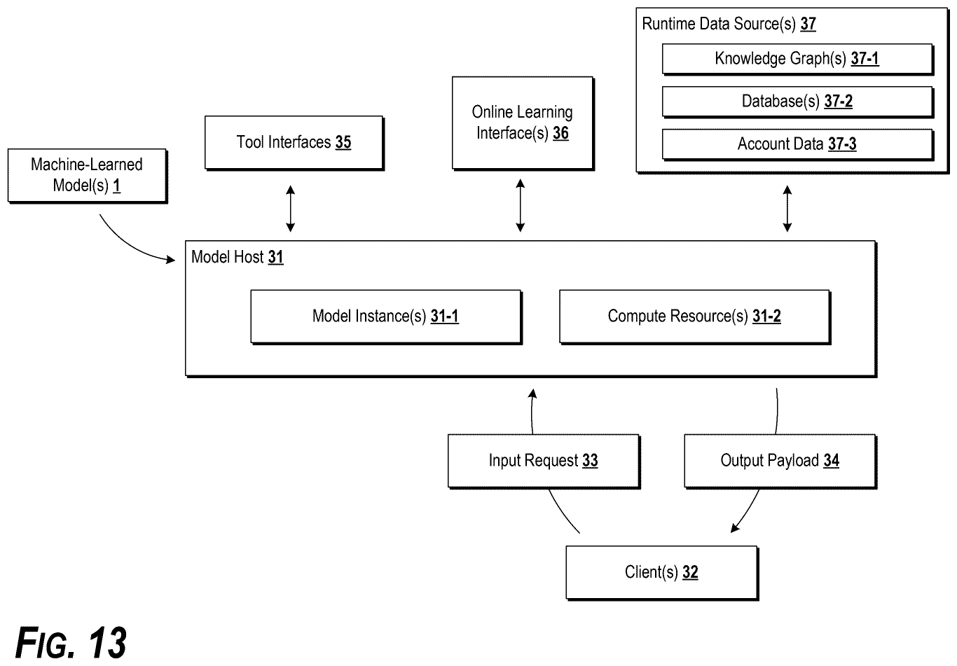

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute context manager 102. Model host 31 can receive encoded representations from a context manager 102 executing on client(s) 32. Model host 31 can receive encoded representations from a context manager 102 executing on runtime data source(s) 37. Model host 31 can maintain a cached context graph and receive graph updates from client(s) 32 or runtime data source(s) 37.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

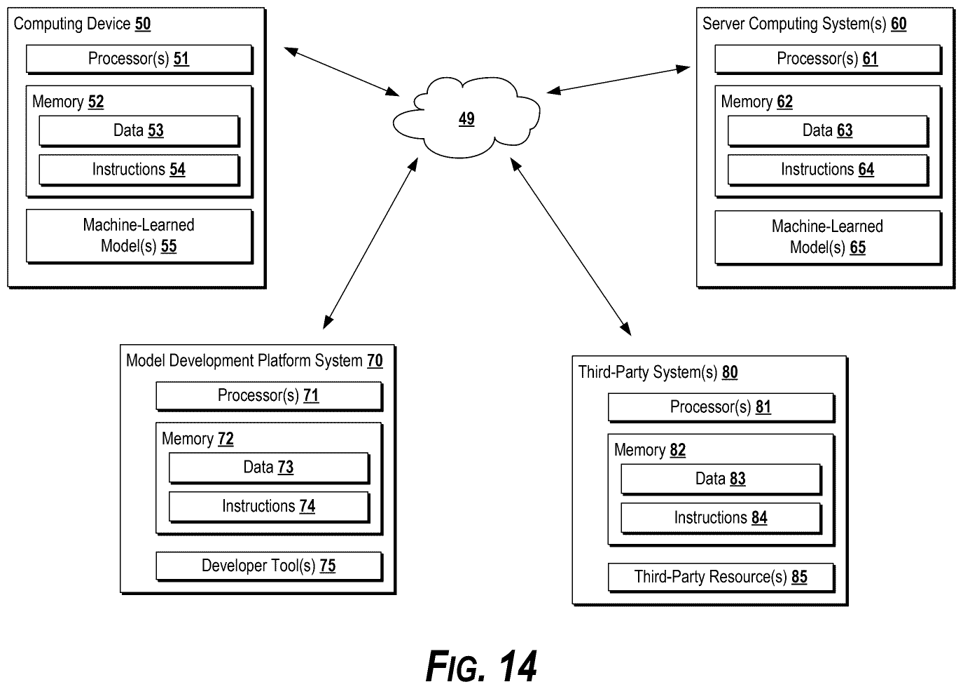

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

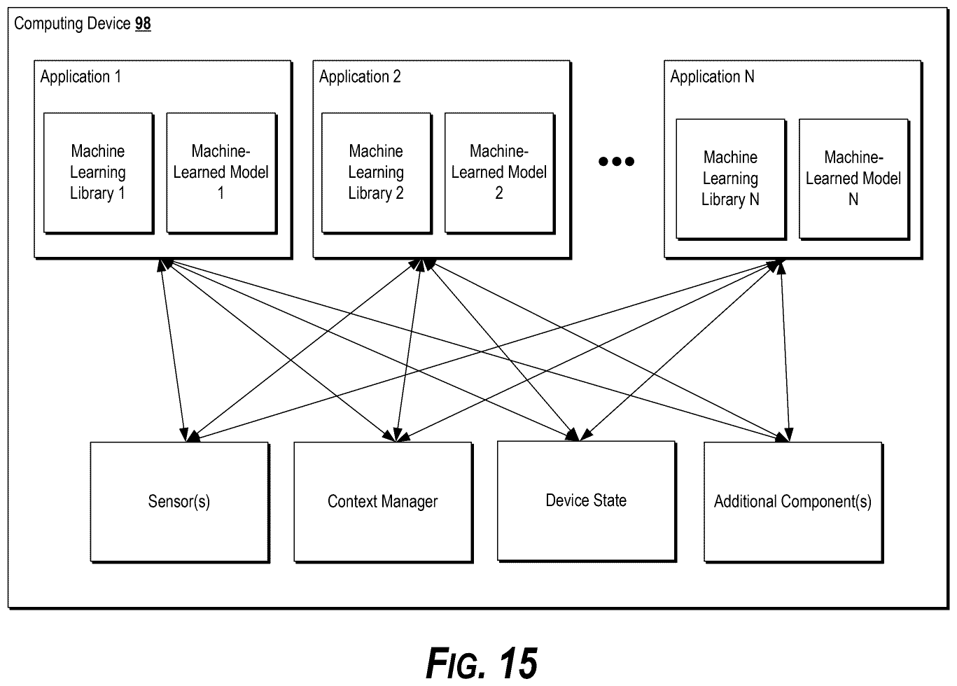

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. Each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

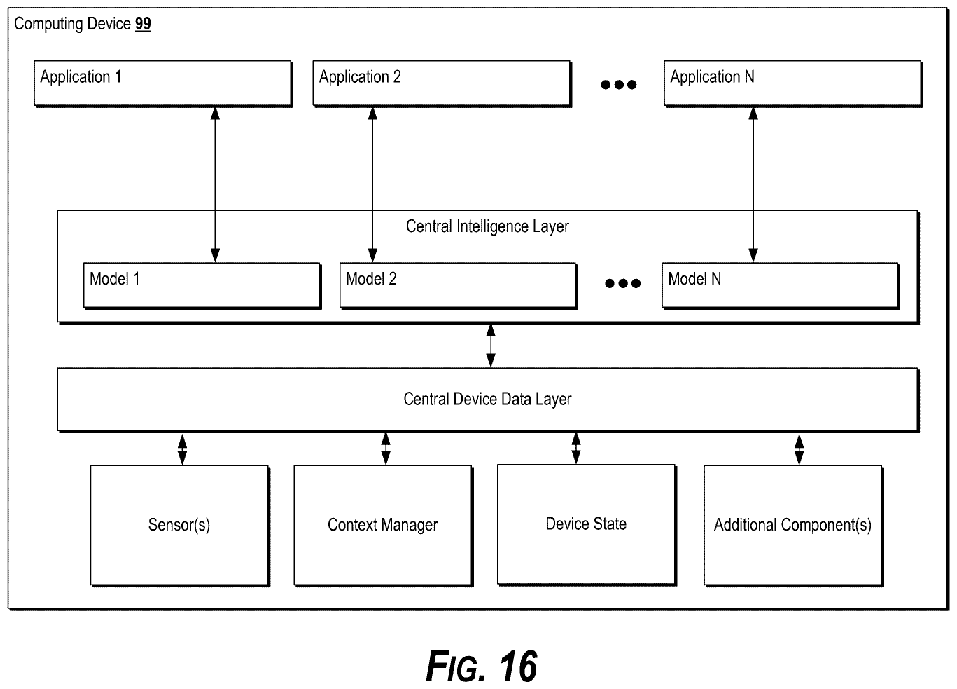

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. The central device data layer can communicate with a number of other components of the computing device, such as, for example, one or more sensors, a context manager, a device state component, or additional components. In some implementations, the central device data layer can communicate with each device component using an API (e.g., a private API).

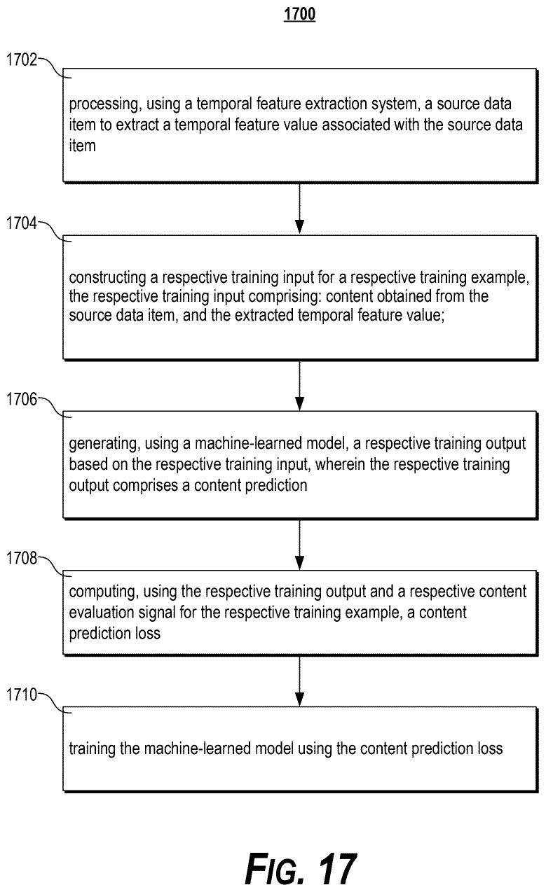

FIG. 17 depicts a flowchart of a method 1700 according to aspects of the present disclosure. For instance, an example machine-learned model can include one or more machine-learned models 1, such as machine-learned model 114.

One or more portion(s) of example method 1700 can be implemented by a computing system that includes one or more computing devices such as, for example, computing systems described with reference to the other figures. Each respective portion of example method 1700 can be performed by any (or any combination) of one or more computing devices. Moreover, one or more portion(s) of example method 1700 can be implemented on the hardware components of the device(s) described herein, for example, to train one or more systems or models. FIG. 17 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 17 is described with reference to elements/terms described with respect to other systems and figures for exemplary illustrated purposes and is not meant to be limiting. One or more portions of example method 1700 can be performed additionally, or alternatively, by other systems.

At 1702, example method 1700 can include processing, using a temporal feature extraction system, a source data item to extract a temporal feature value associated with the source data item. For example, temporal feature extraction system 104 can process source data item 102 to extract temporal feature value 112.

At 1704, example method 1700 can include constructing a respective training input for a respective training example. An example training input is training input 108. The respective training input can include content obtained from the source data item (e.g., content 110) and the extracted temporal feature value.

At 1706, example method 1700 can include generating, using a machine-learned model, a respective training output based on the respective training input. For example, machine-learned model 114 can generate training output 116 based on training input 108. In some implementations of example method 1700, the respective training output includes a content prediction. For example, training output 116 can include content prediction 118.

At 1708, example method 1700 can include computing, using the respective training output and a respective content evaluation signal for the respective training example, a content prediction loss. For example, model training system 120 can compute content prediction loss 122 based on training output 116 and content evaluation signals 124.

At 1710, example method 1700 can include training the machine-learned model using the content prediction loss. For example, model training system 120 can provide parameter updates 126 to train machine-learned model 114.

In some implementations of example method 1700, the temporal feature extraction system includes a machine-learned sequence processing model. For instance, temporal feature extraction system 104 can include a machine-learned sequence processing model, such as machine-learned sequence processing model 1. In some implementations of example method 1700, processing, using the temporal feature extraction system, the source data item to extract a temporal feature value includes processing, using the sequence processing model, the source data item. In some implementations of example method 1700, processing, using the temporal feature extraction system, the source data item to extract a temporal feature value includes generating, using the sequence processing model, the temporal feature value based on the source data item. For example, machine-learned sequence processing model 4 can autoregressively generate a sequence of tokens indicating the temporal feature value.

In some implementations of example method 1700, the temporal feature extraction system extracts the temporal feature value from a metadata field of a metadata object associated with the source data item. For example, temporal feature extraction system 104 can parse a textual metadata object using regular expressions to extract patterns matching date or time values. Temporal feature extraction system 104 can process a textual metadata object using a machine-learned model and predict a likely date or time value conditioned on the metadata object, wherein data or time values in the metadata object may generally be high likelihood outputs.

In some implementations, example method 1700 includes chunking the source data item into a plurality of chunks. For example, a system can chunk content from source data item 102 into chunks that each contain a portion of the content. In some implementations, example method 1700 includes processing, using the temporal feature extraction system, each particular chunk of the plurality of chunks to extract a corresponding temporal feature value associated with the particular chunk. For instance, different portions of a document might be associated with different temporal features. In some implementations of example method 1700, the respective training input includes content from one or more chunks of the plurality of chunks. In some implementations of example method 1700, the respective training input includes one or more temporal feature values respectively corresponding to the one or more chunks.

In some implementations of example method 1700, the source data item includes text data. In some implementations of example method 1700, the source data item includes image data. In some implementations of example method 1700, the source data item includes audio data.

In some implementations of example method 1700, the content obtained from the source data item includes content selected from the source data item. For instance, content can be originally from the source data item and retrieved therefrom using indexing (e.g., using string indices, file paths, row/column indicators), cropping (e.g., images), trimming duration (e.g., of audio files, video files), etc.

In some implementations of example method 1700, the content obtained from the source data item includes content generated based on the source data item. For example, content extractor 106 can include a machine-learned sequence processing model that generates content conditioned on the source data item. For instance, a model can generate a textual summary or paraphrase, a restyled image, etc. Content extractor 106 can perform data augmentation to increase a number of training examples associated with a particular temporal feature value.

In some implementations of example method 1700, the extracted temporal feature value includes a timestamp associated with an origin of the source data item. In some implementations of example method 1700, the extracted temporal feature value includes a time interval (e.g., an age). In some implementations of example method 1700, the extracted temporal feature value includes a lower bound timestamp and an upper bound timestamp.

In some implementations of example method 1700, the respective content evaluation signal includes a reference output. For example, a reference output can include a known ground truth signal, such as a labeled answer or existing portions of content that machine-learned model 114 is trying to recover. In some implementations of example method 1700, the respective content evaluation signal includes a reward signal associated with the first respective training output. For example, a reward signal can be based on human feedback, feedback from a reward model, etc.

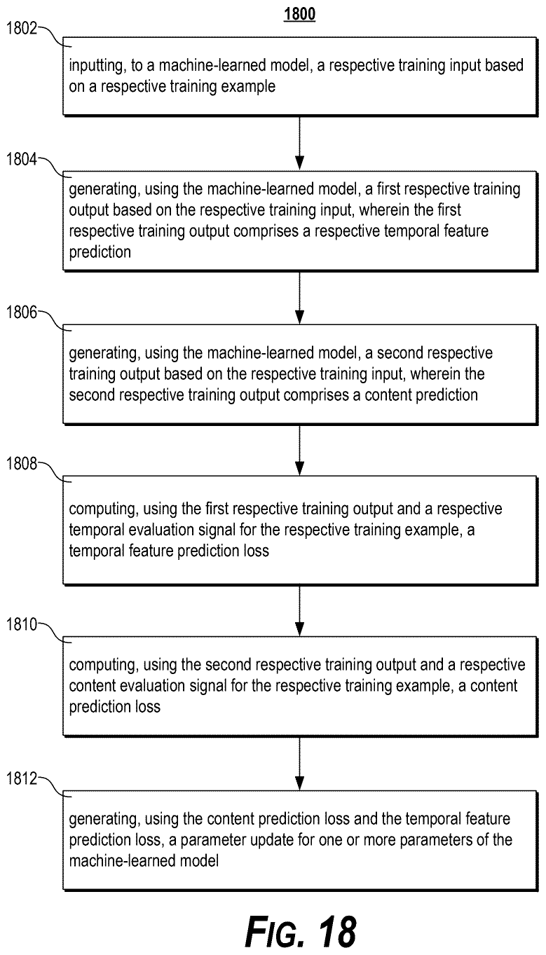

FIG. 18 depicts a flowchart of a method 1800 according to aspects of the present disclosure. For instance, an example machine-learned model can include one or more machine-learned models 1, such as machine-learned model 114.

One or more portion(s) of example method 1800 can be implemented by a computing system that includes one or more computing devices such as, for example, computing systems described with reference to the other figures. Each respective portion of example method 1800 can be performed by any (or any combination) of one or more computing devices. Moreover, one or more portion(s) of example method 1800 can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of example method 1800 can be performed additionally, or alternatively, by other systems.

At 1802, example method 1800 can include inputting, to a machine-learned model, a respective training input based on a respective training example. For example, training input 202 can be input to machine-learned model 114. Training input 202 can be based on training example 200.

At 1804, example method 1800 can include generating, using the machine-learned model, a first respective training output based on the respective training input, wherein the first respective training output includes a respective temporal feature prediction. For example, machine-learned model 114 can generate training outputs 204 based on training input 202. Training outputs 204 can include temporal feature value prediction 206.

At 1806, example method 1800 can include generating, using the machine-learned model, a second respective training output based on the respective training input, wherein the second respective training output includes a content prediction. For example, machine-learned model 114 can generate training outputs 204 based on training input 202. Training outputs 204 can include content prediction 118.

At 1808, example method 1800 can include computing, using the first respective training output and a respective temporal evaluation signal for the respective training example, a temporal feature prediction loss. For example, model training system 120 can compute temporal feature prediction loss 208 based on temporal feature value prediction 206 and temporal evaluation signals 212.

At 1810, example method 1800 can include computing, using the second respective training output and a respective content evaluation signal for the respective training example, a content prediction loss. For example, model training system 120 can compute content prediction loss 122 based on content prediction 118 and content evaluation signals 124.

At 1812, example method 1800 can include generating, using the content prediction loss and the temporal feature prediction loss, a parameter update for one or more parameters of the machine-learned model. For example, model training system 120 can generate parameter updates 126 based on temporal feature prediction loss 208 and content prediction loss 122.

In some implementations of example method 1800, generating, using the machine-learned model, the second respective training output includes generating, using the machine-learned model, the second respective training output based on the respective training input and the first respective training output. For example, content prediction 118 can be conditioned on temporal feature value prediction 206. For instance, machine-learned model 114 can explicitly reason about the date for a particular subject matter (e.g., subject matter of reference material referenced in the output, subject matter of a statement in the output, etc.) and then condition generation of content prediction 118 based on that explicit reasoning.

In some implementations, example method 1800 includes generating a combined loss based on the content prediction loss and the temporal feature prediction loss. In some implementations of example method 1800, the combined loss includes a weighted combination of the content prediction loss and the temporal feature prediction loss.

In some implementations of example method 1800, the first respective training output includes a sequence of tokens representing a temporal feature value. For example, machine-learned model 114 can be a machine-learned sequence processing model 4 configured to generate a sequence of elements or tokens that represent output data, such as a date string. In some implementations of example method 1800, the first respective training output includes a regressed numerical value representing the temporal feature value. For example, machine-learned model 114 can include a numerical regression head that directly outputs a regressed numerical representation of a date.

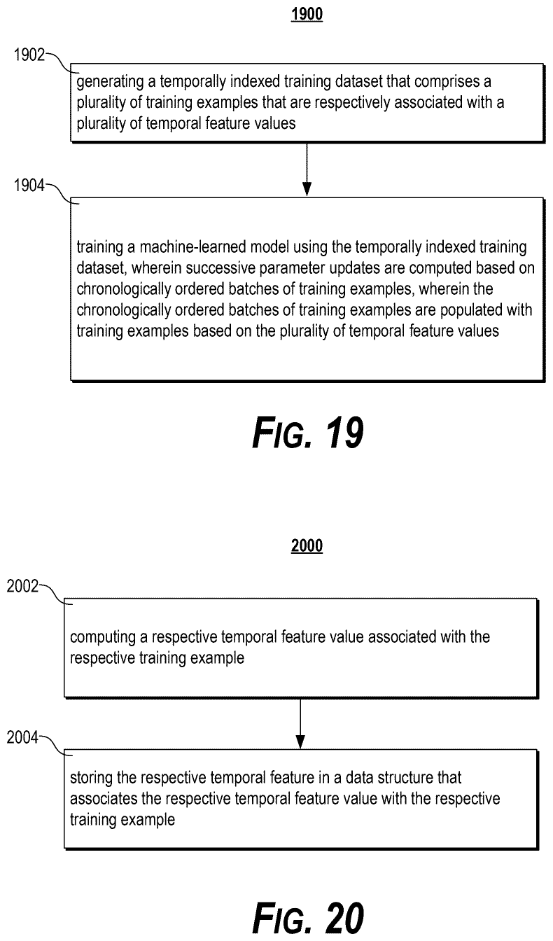

FIG. 19 depicts a flowchart of a method 1900 according to aspects of the present disclosure. For instance, an example machine-learned model can include one or more machine-learned models 1, such as machine-learned model 114.

One or more portion(s) of example method 1900 can be implemented by a computing system that includes one or more computing devices such as, for example, computing systems described with reference to the other figures. Each respective portion of example method 1900 can be performed by any (or any combination) of one or more computing devices. Moreover, one or more portion(s) of example method 1900 can be implemented on the hardware components of the device(s) described herein, for example, to train one or more systems or models. FIG. 19 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 19 is described with reference to elements/terms described with respect to other systems and figures for exemplary illustrated purposes and is not meant to be limiting. One or more portions of example method 1900 can be performed additionally, or alternatively, by other systems.

At 1902, example method 1900 can include generating a temporally indexed training dataset that includes a plurality of training examples that are respectively associated with a plurality of temporal feature values. For example, a temporally indexed dataset can include dataset 300 or 400 or 600. The dataset can be temporally indexed via containing training examples having an indexable date value that can be used to retrieve or sort the examples.

At 1904, example method 1900 can include training a machine-learned model using the temporally indexed training dataset, wherein successive parameter updates are computed based on chronologically ordered batches of training examples, wherein the chronologically ordered batches of training examples are populated with training examples based on the plurality of temporal feature values. For example, parameter updates 406 to machine-learned model 114 can be based on a training batch 402 that contains information having dates that chronologically precede information in training batch 502. Parameter updates 406 can be applied to machine-learned model 114 prior to applying parameter updates 506.

In some implementations of example method 1900, generating the temporally indexed training dataset includes executing example method 2000 for each respective training example of the plurality of training examples.

FIG. 20 depicts a flowchart of a method 2000 according to aspects of the present disclosure.

At 2002, example method 2000 can include computing a respective temporal feature value associated with the respective training example. This can be done as described above with respect to example method 1700.

At 2004, example method 2000 can include storing the respective temporal feature in a data structure that associates the respective temporal feature value with the respective training example.

In some implementations of example method 1900 or 2000, the chronologically ordered batches of training examples include a first batch of training examples including a first plurality of training examples corresponding to a first plurality of temporal features. In some implementations of example method 1900 or 2000, the chronologically ordered batches of training examples include a second batch of training examples including a second plurality of training examples corresponding to a second plurality of temporal features. In some implementations of example method 1900 or 2000, times indicated by the first plurality of temporal features chronologically precede times indicated by the second plurality of temporal features.

In some implementations of example method 1900 or 2000, the first batch includes a first portion of a first ordering track that includes the first plurality of training examples. Example ordering tracks are described above with respect to FIGS. 4 to 6. In some implementations of example method 1900 or 2000, the first batch includes a first portion of a second ordering track that includes a third plurality of training examples corresponding to a third plurality of temporal features. In some implementations of example method 1900 or 2000, the second batch includes a second portion of the first ordering track that includes the second plurality of training examples. In some implementations of example method 1900 or 2000, the second batch includes a second portion of the second ordering track that includes a fourth plurality of training examples corresponding to a fourth plurality of temporal features.

In some implementations, example method 1900 or 2000 includes computing an orthogonality measure between one or more first training examples from the first plurality of training examples or the second plurality of training examples. In some implementations, example method 1900 or 2000 includes computing an orthogonality measure between one or more second training examples from the third plurality of training examples or the fourth plurality of training examples. In some implementations, example method 1900 or 2000 includes constructing the first ordering track and the second ordering track based on the orthogonality measure.

In some implementations, example method 1900 or 2000 includes receiving, after the training of the machine-learned model, new training examples, wherein the new training examples correspond to temporal feature values that chronologically follow the plurality of temporal feature values. In some implementations, example method 1900 or 2000 includes training the machine-learned model using the new training examples.

In some implementations of example method 1900 or 2000, the chronologically ordered batches of training examples include undated training examples interleaved among dated training examples.

In some implementations, example method 1900 or 2000 includes interleaving the undated training examples among dated training examples based on sampling (e.g., random sampling according to a normal distribution or other prior distribution) of a value that indicates insertion of an undated training example into a batch. In some implementations, example method 1900 or 2000 includes uniformly interleaving the undated training examples among dated training examples.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of training machine-learned models, the method comprising:
processing, using a temporal feature extraction system, a source data item to extract a temporal feature value associated with the source data item;
constructing a respective training input for a respective training example, the respective training input comprising:
content obtained from the source data item, and
the extracted temporal feature value;
generating, using a machine-learned model, a respective training output based on the respective training input, wherein the respective training output comprises a content prediction;
computing, using the respective training output and a respective content evaluation signal for the respective training example, a content prediction loss; and
training the machine-learned model using the content prediction loss.

2. The computer-implemented method of claim 1, wherein the temporal feature extraction system comprises a machine-learned sequence processing model, and wherein processing, using the temporal feature extraction system, the source data item to extract a temporal feature value comprises:
processing, using the machine-learned sequence processing model, the source data item; and
generating, using the machine-learned sequence processing model, the temporal feature value based on the source data item.

3. The computer-implemented method of claim 1, wherein the temporal feature extraction system extracts the temporal feature value from a metadata field of a metadata object associated with the source data item.

4. The computer-implemented method of claim 1, comprising:
chunking the source data item into a plurality of chunks; and
processing, using the temporal feature extraction system, each particular chunk of the plurality of chunks to extract a corresponding temporal feature value associated with the particular chunk;
wherein the respective training input comprises:
content from one or more chunks of the plurality of chunks; and
one or more temporal feature values respectively corresponding to the one or more chunks.

5. The computer-implemented method of claim 1, wherein the source data item comprises:
text data;
image data; or
audio data.

6. The computer-implemented method of claim 1, wherein the content obtained from the source data item comprises:
content selected from the source data item; or
content generated based on the source data item.

7. The computer-implemented method of claim 1, wherein the extracted temporal feature value comprises:
a timestamp associated with an origin of the source data item;
a timestamp associated with a retrieval of the source data item;
a time interval; or
a lower bound timestamp and an upper bound timestamp.

8. The computer-implemented method of claim 1, wherein the respective content evaluation signal comprises:
a reference output; or
a reward signal associated with the respective training output.

9. A computer-implemented method of training machine-learned models, the method comprising:
inputting, to a machine-learned model, a respective training input based on a respective training example;
generating, using the machine-learned model, a first respective training output based on the respective training input, wherein the first respective training output comprises a respective temporal feature prediction;
generating, using the machine-learned model, a second respective training output based on the respective training input, wherein the second respective training output comprises a content prediction;
computing, using the first respective training output and a respective temporal evaluation signal for the respective training example, a temporal feature prediction loss;
computing, using the second respective training output and a respective content evaluation signal for the respective training example, a content prediction loss; and
generating, using the content prediction loss and the temporal feature prediction loss, a parameter update for one or more parameters of the machine-learned model.

10. The computer-implemented method of claim 9, wherein generating, using the machine-learned model, the second respective training output comprises:
generating, using the machine-learned model, the second respective training output based on the respective training input and the first respective training output.

11. The computer-implemented method of claim 9, comprising:
generating a combined loss based on the content prediction loss and the temporal feature prediction loss.

12. The computer-implemented method of claim 11, wherein the combined loss comprises a weighted combination of the content prediction loss and the temporal feature prediction loss.

13. The computer-implemented method of claim 9, wherein the first respective training output comprises:
a sequence of tokens representing a temporal feature value; or
a regressed numerical value representing the temporal feature value.

14. A computer-implemented method of training machine-learned models, the method comprising:
generating a temporally indexed training dataset that comprises a plurality of training examples that are respectively associated with a plurality of temporal feature values, wherein generating the temporally indexed training dataset comprises:
for each respective training example of the plurality of training examples:
computing a respective temporal feature value associated with the respective training example; and
storing the respective temporal feature in a data structure that associates the respective temporal feature value with the respective training example; and
training a machine-learned model using the temporally indexed training dataset, wherein successive parameter updates are computed based on chronologically ordered batches of training examples, wherein the chronologically ordered batches of training examples are populated with training examples based on the plurality of temporal feature values.

15. The computer-implemented method of claim 14, wherein the chronologically ordered batches of training examples comprise:
a first batch of training examples comprising a first plurality of training examples corresponding to a first plurality of temporal features; and
a second batch of training examples comprising a second plurality of training examples corresponding to a second plurality of temporal features;
wherein times indicated by the first plurality of temporal features chronologically precede times indicated by the second plurality of temporal features.

16. The computer-implemented method of claim 15, wherein:
the first batch comprises:
a first portion of a first ordering track that comprises the first plurality of training examples; and
a first portion of a second ordering track that comprises a third plurality of training examples corresponding to a third plurality of temporal features; and
the second batch comprises:
a second portion of the first ordering track that comprises the second plurality of training examples; and
a second portion of the second ordering track that comprises a fourth plurality of training examples corresponding to a fourth plurality of temporal features;
wherein times indicated by the third plurality of temporal features chronologically precede times indicated by the fourth plurality of temporal features; and
wherein:
at least one time indicated by the fourth plurality of temporal features chronologically precedes at least one time indicated by the first plurality of temporal features; or
at least one time indicated by the second plurality of temporal features chronologically precedes at least one time indicated by the third plurality of temporal features.

17. The computer-implemented method of claim 16, comprising:
computing an orthogonality measure between:
one or more first training examples from the first plurality of training examples or the second plurality of training examples; and
one or more second training examples from the third plurality of training examples or the fourth plurality of training examples; and
constructing the first ordering track and the second ordering track based on the orthogonality measure.

18. The computer-implemented method of claim 14, comprising:
receiving, after the training of the machine-learned model, new training examples, wherein the new training examples correspond to temporal feature values that chronologically follow the plurality of temporal feature values; and
training the machine-learned model using the new training examples.

19. The computer-implemented method of claim 14, wherein the chronologically ordered batches of training examples comprise undated training examples interleaved among dated training examples.

20. The computer-implemented method of claim 19, comprising:
interleaving the undated training examples among dated training examples based on random sampling of a value that indicates insertion of an undated training example into a batch; or
uniformly interleaving the undated training examples among dated training examples.
